(19) United States
(12) Patent Application Publication
(10) Pub. No.: US 2009/0148018 A1
(43) Pub. Date: Jun. 11, 2009

(54) Image segmentation technique for displaying myocardial perfusion that does not show the microbubbles in the cardiac chambers

(75) Inventors: Michalakis Averkiou, Kirkland, WA (US); Matthew Bruce, Seattle, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,031

(22) PCT Filed: Jan. 21, 2005
(86) PCT No.: PCT/IB05/50251

§ 371 Date: Jul. 7, 2006

Related U.S. Application Data
(60) Provisional application No. 60/539,301, filed on Jan. 26, 2004.

(51) Int. Cl. G06K 9/00

(52) U.S. Cl. 382/131

(57) ABSTRACT

A method and a device for conducting perfusion studies on myocardial tissues with contrast agents is provided. In accordance with the method, ultrasound pulses are transmitted (111) into a patient, and ultrasound echoes of the pulses are received (113) which correspond to both myocardial tissue blood and chamber blood within said patient. The received ultrasound echoes are converted (115) into image data which corresponds to essentially only the myocardium perfusion.

The present invention relates generally to ultrasonic diagnostic imaging techniques, and more particularly to image manipulation techniques for ultrasonic diagnostic imaging that distinguish blood flow in the myocardium from blood flow in the cardiac chambers.

Diagnostic ultrasound equipment transmits sound energy into the human body and receives the signals that reflect off of tissues and organs, such as the heart, liver, and kidneys. Blood flow patterns are obtained from Doppler shifts or from shifts in time domain cross correlation functions, due to red blood cell motion. These produce reflected sound waves and may be generally displayed in a two-dimensional format known as color flow imaging or color velocity imaging. Generally, the amplitudes of reflected components for structures such as the heart or vessel walls have lower absolute velocities and are 20 dB to 40 dB (10-100 times) larger than reflected components due to blood cells.

In general, an ultrasound system emits pulses over a plurality of paths and converts echoes received from objects on the plurality of paths into electrical signals used to generate ultrasound data from which an ultrasound image can be displayed. The process of obtaining the raw data from which the ultrasound data is produced is typically termed “scanning,” “sweeping,” or “steering a beam”.

Real-time sonography refers to the presentation of ultrasound images in a rapid sequential format as the scanning is being performed. Scanning is either performed mechanically (by physically oscillating one or more transducer elements) or electronically. By far, the most common type of scanning in modern ultrasound systems is electronic, wherein a group of transducer elements (termed an “array”) arranged in a line are excited by a set of electrical pulses, one pulse per element, timed to construct a sweeping action.

One of the most requested features on ultrasound systems is the ability to present an image having the appearance of a three-dimensional object. Such an image is produced from a three-dimensional data matrix. This volume of data is processed to create an image for display on a two-dimensional surface that has the appearance of being three-dimensional. Such processing is typically referred to as a rendering.

While some three-dimensional optimized ultrasound systems are available, most commercial ultrasound systems today display only planar two-dimensional images, acquiring scan data from one-dimensional array probes. The SONOS 5500 sold by Philips Medical Systems, Andover, Mass. (formerly known as AGILENT TECHNOLOGIES, Inc.), is one example of one such system. Some commercial systems, including the SONOS 5500, can generate three-dimensional ultrasound images with the help of “off-line” post-processing. To do this, sequences of regularly spaced planar two-dimensional sweeps are collected as the position of the probe is translated or rotated in some way between scan frames. Post-processing manipulation reconstructs three-dimensional data sets using acquired position information for each two-dimensional scan plane. The resulting three-dimensional data sets are displayed as rendered images, typically on a separate workstation, using any of various well-known, computation-intensive rendering techniques. Furthermore, the real-time rendering and display workstation may be integrated with the ultrasound scanner into one system. One such system is the Sonos 7500 sold by Philips Medical Systems.

Various imaging technologies have been developed for use in sonography. One common type, called color Doppler velocity imaging, involves the acquisition of Doppler data at different locations, called sample volumes, over the image plane of an ultrasonic image. The Doppler data is acquired over time and is used to estimate the phase shift over succeeding transmit events, at each discrete sample volume. The phase shift relates to the velocity of fluid flow in vessels within the body, with the polarity of the shift indicating direction of flow towards and away from the transducer. This information is color coded in accordance with the magnitude of the shift (i.e., its velocity) and its polarity and is then overlaid on a structural image of the image plane. The colors in the image provide an indication of the speed of blood flow and its direction.

Another type of imaging technology, referred to as color power Doppler, focuses on the intensity of received signals which exhibit a Doppler shift. This type of technology is described, for example, in U.S. Pat. No. 5,471,990 (Thirsk). The Doppler signal intensity is computed for each sample volume in an image plane and is displayed, using a color derived from a color map. Unlike color Doppler velocity imaging, color power Doppler imaging does not exhibit the problems of direction determination, aliasing and low sensitivity (which are characteristic of velocity imaging). Color power Doppler simply displays the Doppler signal intensity at a sample volume in a coded color.

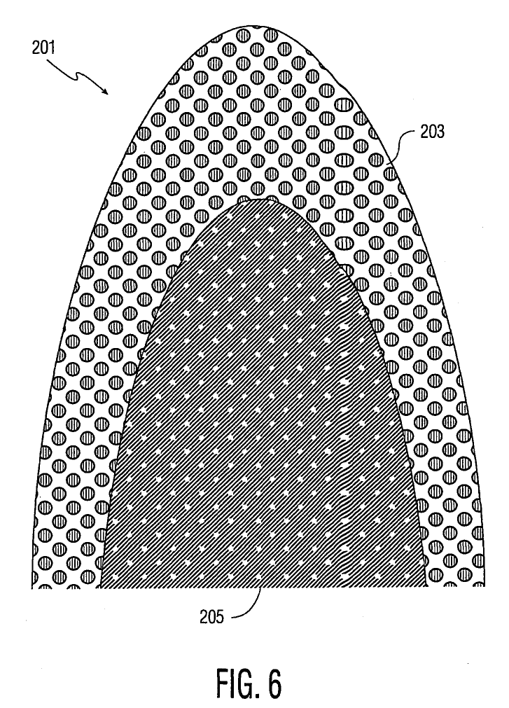

Both 2D gray scale and color power Doppler displays find use in perfusion studies, that is, situations in which it is desirable to assess blood perfusion in an organ or Structure in the body. Such perfusion studies are facilitated by injection of contrast agents, which may include microscopic bubbles that provide good ultrasound return signals. These contrast agents enable bright imaging of the blood flow, both in the heart chambers and in the heart wall. Theoretically, such contrast agents should enable excellent differential imaging of the cardiac wall blood flow where, in the case of a myocardial infarct, lessened heart muscle blood flow should readily be distinguishable from healthy myocardium blood flow. In practice, however, the brightness levels from the chamber blood flow are sufficiently high that blood flow in the cardiac wall is difficult to distinguish, even in the case of an infarct. This situation is represented in FIG. 6, which is a schematic illustration of a typical image 201 with bubbles showing in both the myocardium (MC) 203 and left ventricle (LV) 205.

Some attempts have been made in the art to develop methods which distinguish chamber blood flow from the blood flow in myocardial tissues. For example, U.S. Pat. No. 5,800,357 (Witt et al.) discloses an ultrasound Doppler power imaging system for distinguishing tissue blood flow from chamber blood flow. In the approach described therein, filters are used to threshold out chamber blood flow. However, Witt et al. do not consider contrast agents. The technique disclosed in Witt et al. is also not applicable to perfusion studies, since conventional Doppler systems without contrast agents are not capable of detecting blood flow in microcirculation. It is additionally noted that velocities associated with perfusion are lower than velocities associated with chamber walls. However, the approach disclosed in Witt et al. relies solely on differentiating blood flow velocities in the macrocirculation by applying different wall filters to scatterers moving with different velocities, and thus displays only vessels that are greater than a certain diameter and that have velocities that are detectable with conventional Doppler techniques. Moreover, image segmentation is not considered in Witt et al. However, a technique which produces images similar to other widely used imaging techniques, such as single positron emission tomography (SPECT), would be preferable, because the clinician would require little or no further training in order to work with the image.

There is thus a need in the art for methods and devices for performing perfusion studies that overcome these problems. In particular, there is a need in the art for methods and devices for performing perfusion studies on tissues, such as myocardial tissues, which overcome contrast issues that arise from the imaging of bubbles in the surrounding environment, and which produce images and renderings similar to those produced by other imaging techniques, such as SPECT. These and other needs are met by the methodologies and devices disclosed herein.

In one aspect, a method for conducting perfusion studies on myocardial tissues is provided. In accordance with the method, ultrasound pulses are transmitted into a patient after an intravenous injection of a microbubble contrast agent, and echoes from the blood are received which correspond to both myocardial tissue blood flow and chamber blood flow within the patient. The received ultrasound echoes are converted into image data which corresponds to essentially only the myocardium perfusion. This conversion may be accomplished, for example, by (a) converting the received ultrasound echoes into a first set of echo pattern data signals from which the blood within the chamber is detectable, (b) converting the received ultrasound echoes into a second set of echo pattern data signals from which the blood within both the chamber and myocardial tissue is detectable, and (c) eliminating from the second data set echo pattern data signals which positionally correspond to features which produced echo pattern data signals in the first set.

In another aspect, an image is created that contains information of the blood velocity in the chamber and muscle. The image also includes very small vessels (capillaries) where the blood velocity is effectively zero (not moving). The detection of very slow moving blood in the capillaries is performed with nonlinear imaging techniques like Pulse Inversion or Power Modulation. The final image then displays only the slow moving (or not moving) blood by removing targets that are moving faster than a threshold velocity, which results in a display that shows only the myocardium blood and not the chamber blood.

In another aspect, a device is provided for conducting perfusion studies on myocardial tissues. The device comprises a transmitter adapted to transmit ultrasound pulses into a patient, a receiver adapted to receive echoes of said ultrasound pulses which correspond to both myocardial tissue blood and chamber blood within said patient, and a processor adapted to convert the received ultrasound echoes into image data which corresponds to essentially only the myocardial blood. The processor is preferably adapted to convert the received ultrasound echoes into a first set of echo pattern data signals from which the blood within the chamber is detectable, and is preferably further adapted to convert the received ultrasound echoes into a second set of echo pattern data signals from which the blood within both the chamber and myocardial tissue is detectable. The processor is also preferably adapted to eliminate from the second data set echo pattern data signals which positionally correspond to features which produced echo pattern data signals in the first set.

These and other aspects of the teachings herein are described in further detail below.

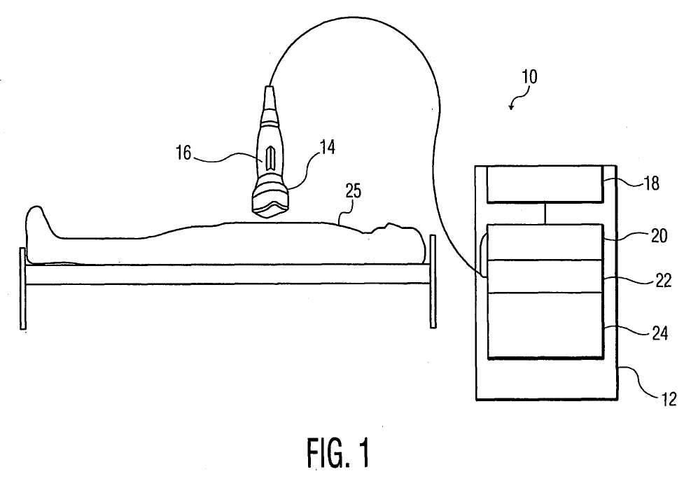

FIG. 1 is an illustration of an ultrasound device which may be used to implement the methodologies disclosed herein;

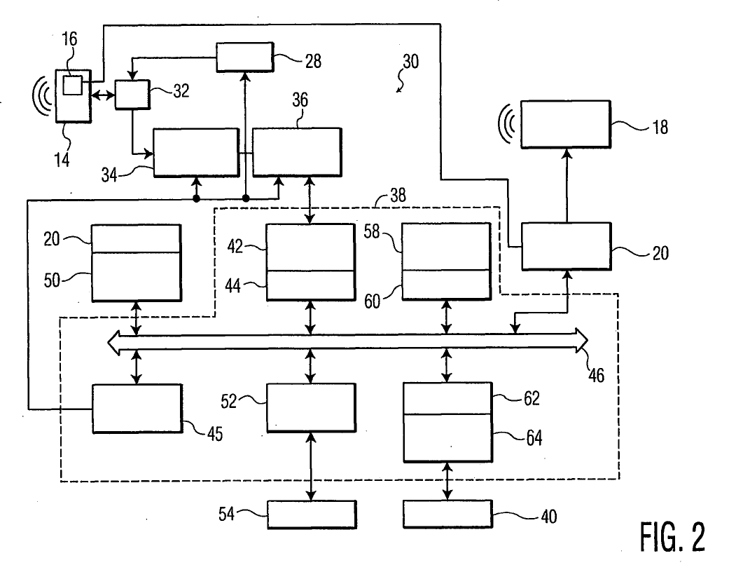

FIG. 2 is a schematic diagram illustrating the functional elements of a device of the type depicted in FIG. 1;

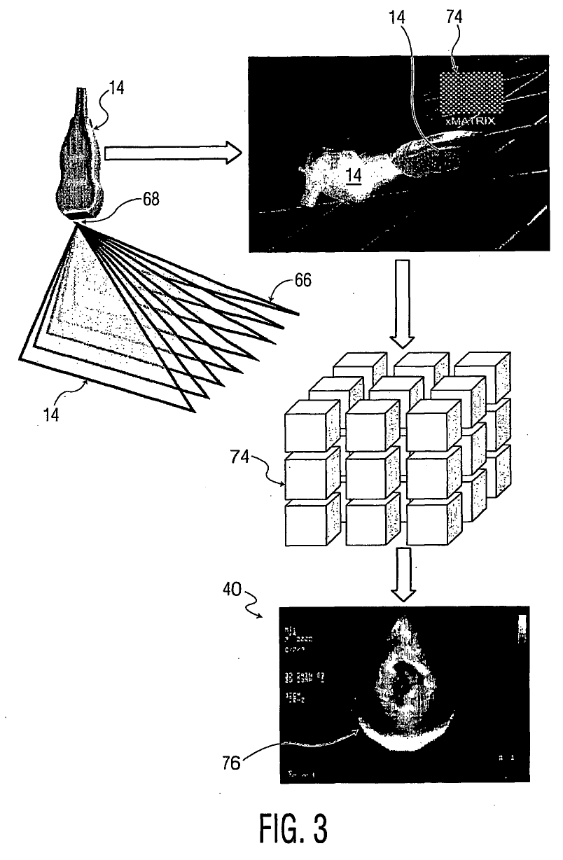

FIG. 3 is an illustration of an ultrasound imaging process;

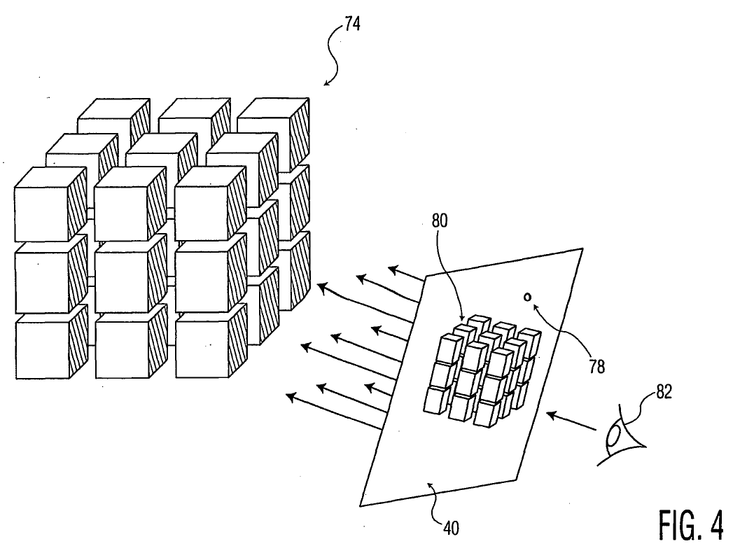

FIG. 4 is an illustration of the voxels shown in FIG. 3;

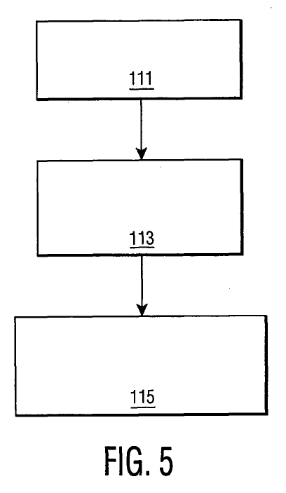

FIG. 5 is a flow chart depicting the logic process of an image segmentation scheme of the type disclosed herein;

FIG. 6 is an illustration of a myocardial perfusion study in which microbubbles in both the myocardium and the left ventricle are imaged;

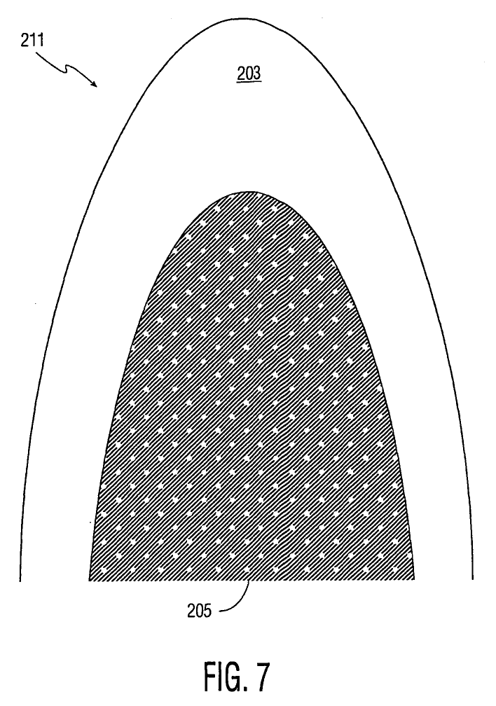

FIG. 7 is an illustration of a myocardial perfusion study in which microbubbles in only the left ventricle are imaged; and

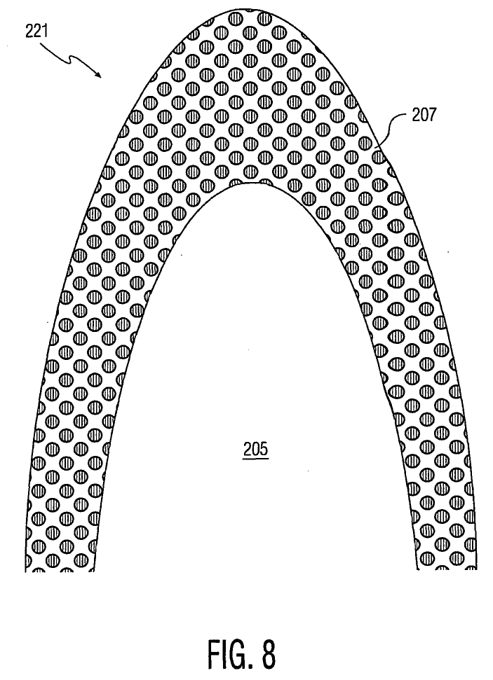

FIG. 8 is an illustration of a myocardial perfusion study in which microbubbles in only the myocardium are imaged.

Methods and devices are provided herein for performing perfusion studies on myocardial tissues and other such subjects. These methods and devices overcome contrast issues of the type that arise from the imaging of bubbles in the environment surrounding the tissues to be imaged. This is accomplished by novel image data segmentation schemes (including velocity segmentation schemes) and image data subtraction schemes which give rise to an image devoid of imaging information associated with the environment, and in particular, the imaging information from the chamber. The resulting images are similar to those obtained in nuclear single-photon emission computed tomography (SPECT). Consequently, the images generated by these techniques are readily understood by clinicians experienced with SPECT, so that little or no additional training is required for such clinicians to work with the images.

The preferred embodiments of the methodologies and devices disclosed herein, and the advantages of these methodologies and devices, are best understood by referring to FIGS. 1-8 of the drawings, like numerals being used for like and corresponding parts of the various drawings.

FIG. 1 shows a simplified block diagram of an ultrasound imaging system 10 that may be used in the implementation of the methodologies disclosed herein. It will be appreciated by those of ordinary skill in the relevant arts that ultrasound imaging system 10, as illustrated in FIG. 1, and the operation thereof as described hereinafter, is intended to be generally representative of such systems and that any particular system may differ significantly from that shown in FIG. 1, particularly in the details of construction and in the operation of such system. As such, ultrasound imaging system 10 is to be regarded as illustrative and exemplary, and not limiting, as regards the methodologies and devices described herein or the claims attached hereto.

Ultrasound imaging system 10 generally includes ultrasound unit 12 and connected transducer 14. Transducer 14 includes spatial locator receiver (or simply “receiver”) 16. Ultrasound unit 12 has integrated therein spatial locator transmitter (or simply “transmitter”) 18 and associated controller 20. Controller 20 provides overall control of the system by providing timing and control functions. As will be discussed in detail below, the control routines include a variety of routines that modify the operation of receiver 16 so as to produce a volumetric ultrasound image as a live real-time image, a previously recorded image, or a paused or frozen image for viewing and analysis.

Ultrasound unit 12 is also provided with imaging unit 22 for controlling the transmission and receipt of ultrasound, and image processing unit 24 for producing a display on a monitor (See FIG. 2). Image processing unit 24 contains routines for rendering a three-dimensional image. Transmitter 18 is preferably located in an upper portion of ultrasound unit 12 so as to obtain a clear transmission to receiver 16. Although not specifically illustrated, the ultrasound unit described herein may be configured in a cart format.

During freehand imaging, a user moves transducer 14 over subject 25 in a controlled motion. Ultrasound unit 12 combines image data produced by imaging unit 22 with location data produced by the controller 20 to produce a matrix of data suitable for rendering onto a monitor (See FIG. 2). Ultrasound imaging system 10 integrates image rendering processes with image processing functions using general purpose processors and PC-like architectures. On the other hand, use of ASICs to perform the stitching and rendering is possible.

FIG. 2 is a block diagram 30 of an ultrasound system that may be used in the practice of the methodologies disclosed herein. The ultrasound imaging system shown in FIG. 2 is configured for the use of pulse generator circuits, but could be equally configured for arbitrary waveform operation. Ultrasound imaging system 10 uses a centralized architecture suitable for the incorporation of standard personal computer (“PC”) type components and includes transducer 14 which, in a known manner, scans an ultrasound beam, based on a signal from a transmitter 28, through an angle. Backscattered signals, i.e., echoes, are sensed by transducer 14 and fed, through receive/transmit switch 32, to signal conditioner 34 and, in turn, to beamformer 36. Transducer 14 includes elements which are preferably configured as a steerable two-dimensional array. Signal conditioner 34 receives backscattered ultrasound signals and conditions those signals by amplification and forming circuitry prior to their being fed to beamformer 36. Within beamformer 36, ultrasound signals are converted to digital values and are configured into “lines” of digital data values in accordance with amplitudes of the backscattered signals from points along an azimuth of the ultrasound beam.

Beamformer 36 feeds digital values to application specific integrated circuit (ASIC) 38 which incorporates the principal processing modules required to convert digital values into a form more conducive to video display that feeds to monitor 40. Front end data controller 42 receives lines of digital data values from beamformer 36 and buffers each line, as received, in an area of buffer 44. After accumulating a line of digital data values, front end data controller 42 dispatches an interrupt signal, via bus 46, to shared central processing unit (CPU) 48. CPU 48 executes control procedures 50 including procedures that are operative to enable individual, asynchronous operation of each of the processing modules within ASIC 38. More particularly, upon receiving an interrupt signal, CPU 48 feeds a line of digital data values residing in buffer 42 to random access memory (RAM) controller 52 for storage in random access memory (RAM) 54 which constitutes a unified, shared memory. RAM 54 also stores instructions and data for CPU 48 including lines of digital data values and data being transferred between individual modules in ASIC 38, all under control of RAM controller 52.

Transducer 14, as mentioned above, incorporates receiver 16 that operates in connection with transmitter 28 to generate location information. The location information is supplied to (or created by) controller 20 which outputs location data in a known manner. Location data is stored (under the control of the CPU 48) in RAM 54 in conjunction with the storage of the digital data value.

Control procedures 50 control front end timing controller 45 to output timing signals to transmitter 28, signal conditioner 34, beamformer 36, and controller 20 so as to synchronize their operations with the operations of modules within ASIC 38. Front end timing controller 45 further issues timing signals which control the operation of the bus 46 and various other functions within the ASIC 38.

As previously noted, control procedures 50 configure CPU 48 to enable front end data controller 44 to move the lines of digital data values and location information into RAM controller 52, where they are then stored in RAM 54. Since CPU 48 controls the transfer of lines of digital data values, it senses when an entire image frame has been stored in RAM 54. At this point, CPU 48 is configured by control procedures 50 and recognizes that data is available for operation by scan converter 58. At this point, therefore, CPU 48 notifies scan converter 58 that it can access the frame of data from RAM 54 for processing.

To access the data in RAM 54 (via RAM controller 52), scan converter 58 interrupts CPU 48 to request a line of the data frame from RAM 54. Such data is then transferred to buffer 60 of scan converter 58 and is transformed into data that is based on an X-Y coordinate system. When this data is coupled with the location data from controller 20, a matrix of data in an X-Y-Z coordinate system results. A four-dimensional matrix may be used for 4-D (X-Y-Z-time) data. This process is repeated for subsequent digital data values of the image frame from RAM 54. The resulting processed data is returned, via RAM controller 52, into RAM 54 as display data. The display data is typically stored separately from the data produced by beamformer 36. CPU 48 and control procedures 50, via the interrupt procedure described above, sense the completion of the operation of scan converter 58. Video processor 62, such as the MITSUBISHI VOLUMEPRO series of cards, interrupts CPU 48 which responds by feeding lines of video data from RAM 54 into buffer 62, which is associated with the video processor 64. Video processor 64 uses video data to render a three-dimensional volumetric ultrasound image as a two-dimensional image on monitor 40.

FIG. 3 shows conceptually the process used to obtain images as described herein, beginning with ultrasound propagation and continuing through to the display of a volumetric ultrasound image on computer monitor 40. In the example shown in FIG. 3, there are slices 66 conjoined at single apex 68, but otherwise separated. Each of scan lines 70 in slices 66 has a matching (or “indexed”) scan line in the other slices. Preferably, scan lines 70 with the same lateral position are matched across the set of slices. One way to accomplish this is to index each of scan lines in a slice by numbering them in sequence, in which case scan lines 70 having the same index value can be easily matched.

To render a volumetric three-dimensional image, data points on each of sets of matched scan lines 68 are linearly combined using an addition routine. In other words, each slice in the set of slices is accumulated in the elevation direction to produce an aggregate slice for subsequent display. Preferably, but not necessarily, the data points in each slice are weighted, for example, on a line-by-line basis by using a multiply and accumulate routine (also known as a “MAC routine”).

FIG. 3 further illustrates the processing of ultrasound data, for example of human heart 72, using volumetric ultrasound processing for which the methodologies disclosed herein have particular beneficial application. In such processing, a live, three-dimensional ultrasound architecture may be employed that instantaneously processes data from slice 66 arising from the use of transducer 14 to produce voxel matrix 74 of data. Voxel matrix 72, through the use a powerful supercomputer architecture such as that of the SONOS 7500 System manufactured by Philips Medical Systems, processes within a small amount of time, nominally 50 milliseconds, streaming three-dimensional ultrasound data. This processed ultrasound data may then appear on a monitor 40 screen to show in real-time, oscillating ultrasound object 76.

The three-dimensional system such as the SONOS 7500 with which the methodologies disclosed herein may be utilized operates uses transducer 14, which includes a 3000-element array, and associated microprocessors that preprocess data using an advanced, yet PC-based, computing platform, as well as special software that allows interactive image manipulation and an easy-to-use operator interface. The 3000-element array captures data about an ultrasound object, such as the heart, as a volume. By combining a transducer crystal that is etched to have the necessary number of crystals with a microprocessing circuit that efficiently triggers the transducer elements, the ultrasonic imaging system with which the methodologies disclosed herein may be utilized harnesses the computing power of more than 150 computer boards.

The processing architecture includes both hardware and software that allows real-time generation of volume data. This PC-based technology supports instantaneous display of three-dimensional images. With this technology, the ultrasound imaging system applies the 3000 channels to the SONOS 7500 mainframe beamformer for scanning in real time. Three-dimensional scan converter 58 processes at a rate of over 0.3 giga-voxels per second to produce image 76 of oscillating ultrasound 74.

The methodologies disclosed herein, therefore, may be employed in a three-dimensional live ultrasound imaging and display process to enhance known echocardiography analysis and diagnosis. The system with which the methodologies disclosed herein may operate has the ability to generate and display three-dimensional images of a beating heart an instant after the data are acquired. However, while not preferred, the methodologies disclosed herein may also be used with other, so called, real-time three-dimensional systems which may need several seconds to acquire the data and additional time to reconstruct it as a three-dimensional ultrasound display. In such systems, data acquisition leading to three-dimensional ultrasound images of the heart may be gated for electrocardiogram and respiration analysis and diagnosis.

Various imaging techniques may be utilized in the methodologies disclosed herein to create image data. These include pulse inversion (PI), power pulse inversion (PPI), and power modulation (PM). In conventional harmonic imaging, the bandwidth is restricted to try to reduce the overlap between the transmitted signal and that of received harmonics. The above mentioned techniques avoid these bandwidth limitations by subtracting rather than filtering out the fundamental signal. Consequently, a larger bandwidth may be used with higher resolution and an increased sensitivity to contrast agents. PI for example uses 2 pulses that are phased shifted by 180°. Any stationary linear target that responds equally to positive and negative pressures will be canceled, whereas asymmetric bubble oscillation will be enhanced. Linear components of the echoes are subtracted without filtering, whereas the nonlinear components are added.

FIG. 5 illustrates one generalized embodiment of the imaging process described herein. In accordance with the methodology, ultrasound pulses are transmitted 111 into a patient that has been injected with microbubble contrast agent. A series of echoes are received 113 which correspond to both the myocardial tissue blood and the chamber blood within the patient. The echoes are then converted 115 into image data which corresponds to essentially only the myocardium perfusion. Consequently, the features of the myocardium tissues can be studied without being obscured by the chamber. The resulting images are then similar to those obtained by nuclear imaging.

An imaging process of the type depicted in FIG. 5 may be implemented in various ways. One general method of implementing this process is through image data segmentation, including velocity segmentation. Another general method of implementing this process is through image data subtraction. These approaches are discussed in greater detail below.

In an image data segmentation approach, the location of the chamber (e.g., the left ventricle) is determined, and no echoes corresponding to blood flow from that area are displayed. Two specific methods for implementing this approach are described, though one skilled in the art will appreciate that certain variations and modifications of these approaches may also be possible.

In the first method in accordance with this approach, image data segmentation is accomplished by displaying the blood in the myocardium (but not the chamber) in 2D echo mode. In such an approach, the data for Left Ventricle Opacification (LVO) is processed. Techniques that may be used to process the data include, but are not limited to, Doppler schemes or nonlinear schemes such as pulse inversion (PI). The LVO data is then used to determine the location of the chamber. The data for both the perfusion and the LVO are then processed. This may be accomplished, for example, through the use of a nonlinear scheme such as pulse inversion (PI), though the method is not limited to the use of such a scheme. Finally, an image is displayed based only on the data that does not originate from physical locations corresponding to the determined location of the chamber.

In the second method in accordance with this approach, image data segmentation is accomplished by displaying the blood in the myocardium (but not the chamber) in overlay mode (that is, with a background and foreground, as through Power Doppler-like modes). This may be accomplished by generating a gray scale image (fundamental or harmonic) to determine the location of the image plane and to guide the clinician in choosing the correct plane. The steps from the first method described above may then be used to produce the overlay colorized image.

In an image data subtraction approach, the chamber (LV) data is subtracted from the total data (LV+MC) with the use of a scaling factor w in accordance with the algorithm of EQUATION I:

(LV+MV)−w*LV (EQUATION I)

Two specific methods for implementing this approach are described, though one skilled in the art will appreciate that variations and modifications of these approaches may also be possible.

In the first method in accordance with this approach, image data subtraction is accomplished by displaying the blood flow in the myocardium (but not the chamber) in 2D echo mode. In such an approach, the data for Left Ventricle Opacification (LVO) is processed. Techniques that may be used to process the data include, but are not limited to, Doppler schemes or nonlinear schemes such as pulse inversion (PI). The data for the LVO and for perfusion is then processed. This may be accomplished, for example, through the use of a nonlinear scheme such as pulse inversion (PI), though the method is not limited to the use of such a scheme. The processed LVO data is scaled by “w” and then subtracted from the combined, processed LVO/perfusion data according to EQUATION 1.

As an example of the first method, consider the case where a series of pulses are used. A pulse inversion sequence is then transmitted having the transmit values −1, 1, −1. A pulse sequence A for the LVO is received which is 1, 0, −1 (this is a Doppler scheme). A pulse sequence B for the (MC+LVO) is received which is 1, 2, 1 (this is a nonlinear imaging scheme). The final result is the sequence C, where C is given by EQUATION 1 as C=B−wA, wherein w is a user controlled weight.

In the second method in accordance with this approach, image data subtraction is accomplished by displaying the blood in the myocardium (but not the chamber) in overlay mode (that is, with a background and foreground, as through Power Doppler-like modes). This may be accomplished by generating a gray scale image (fundamental or harmonic) to determine the location of the image plane and to guide the clinician in choosing the correct plane. The steps from the first method described above may then be used to produce the overlay colorized image.

In variations of the overlay schemes noted above, the first set of image data may be generated by 2-3-pulse Doppler. The image data may have a very low dynamic range such that a very smooth appearance is achieved in order for the chamber to have a very uniform image to use for image segmentation purposes. Color image segmentation may then be performed based on the grayscale image data. In some embodiments, this approach may be used in coincident imaging, that is, where the same transmit sequence is used for both the echo (grayscale) image data and the color image amplitude. An example of one possible five pulse sequence in such a scheme is as follows:

| | |
|---|---|
| transmit weights: | 1, −1, 1, −1, 1 |
| echo receive weights: | 0.25, 0, −0.5, 0, 0.25 |
| color receive weights: | 0.0625, 0.25, 0.375, 0.25, 0.0625 |

The echo processing will result in an image wherein only the chamber is shown and wherein the color processing will result in an image in which both the chamber and the myocardium are shown. The location of the chamber is found from the echo image and it is used to segment or subtract from the color image so as to remove the chamber.

Image segmentation may also be achieved in accordance with the teachings herein through a single image mode. In this mode, a single image data set, such as an RF data set, is used to achieve image segmentation. This is accomplished by processing the image data more than once. The 5 pulse scheme described above could be used for this purpose. However, a three pulse sequence is described to indicate that the methods discussed are not limited to a fixed number of pulses:

| | | |
|---|---|---|
| transmit weights: | 1, −1, 1 | |
| Set A receive weights: | 1, 0, −1 | (power Doppler signal) |
| Set B receive weights: | 0.25, 0.5, 0.25 | (2^{nd} harmonic signal) |

The received echoes are processed twice with different weights in order to extract different information every time. In this example, set A shows only chamber bubble information, and hence corresponds to the situation illustrated in FIG. 7 in which the image 211 contains only LV cavity 205 data. Set B shows both chamber bubble information and myocardial tissue information, and hence corresponds to the situation shown in FIG. 6. To equalize the signals in the chamber, a weight w may be applied to band A. Thus, by operating on the image data with the operator Φ(A, B)=B−wA in accordance with EQUATION 1, the signal corresponding to the chamber bubble information can be removed. This situation is illustrated in FIG. 8 in which the image 221 contains only MC 203 data.

Methods and devices have been provided herein for performing perfusion studies on myocardial tissues and other such subjects. These methods and devices overcome contrast issues of the type that arise from the imaging of bubbles in the environment surrounding the tissues to be imaged through novel image segmentation schemes which remove the imaging information associated with the environment, and in particular, the imaging information from the chamber. The resulting images, which show essentially only myocardial perfusion, are similar to those obtained in nuclear single-photon emission computed tomography (SPECT).

The above description of the invention is illustrative, and is not intended to be limiting. It will thus be appreciated that various additions, substitutions and modifications may be made to the above described embodiments without departing from the scope of the present invention. Accordingly, the scope of the present invention should be construed solely in reference to the appended claims.

1. A method for conducting perfusion studies on myocardial tissues with contrast agents, comprising the steps of:
transmitting ultrasound pulses into a patient and receiving ultrasound echoes of the pulses which correspond to blood in both the myocardial tissues and in the chamber;
determining which of the ultrasound echoes correspond to blood in the chamber; and
creating an image which is based on only those ultrasound echoes which do not correspond to blood in the chamber.

2. The method of claim 1, wherein the step of creating an image which is based on only those ultrasound echoes which do not correspond to blood in the chamber comprises the steps of:
converting the received ultrasound echoes into a first set of echo pattern data signals from which blood within the chamber is determinable; and
converting the received ultrasound echoes into a second set of echo pattern data signals from which blood within both the chamber and myocardial tissue is determinable.

3. The method of claim 2, wherein the step of converting the received ultrasound echoes into image data which corresponds to only blood within the myocardial tissue further comprises the step of:
eliminating from the second data set echo pattern data signals which positionally correspond to features which produced echo pattern data signals in the first set.

4. The method of claim 2, further comprising the step of:
creating an image based on said first and second sets of data signals, wherein said first set of data signals is used to eliminate from the image echo pattern data signals which positionally correspond to features which produced echo pattern data signals in the first set.

5. The method of claim 4, wherein the first set of echo pattern data signals is selected from the group consisting of fundamental gray scale image data signals and harmonic gray scale image data signals, and wherein the second set of echo pattern data is derived through a method selected from the group consisting of PPI and PM.

6. The method of claim 5, wherein the second set of echo pattern data is displayed in color mode.

7. The method of claim 6, wherein color write priority is used to eliminate from the image echo pattern data signals which positionally correspond to features which produced echo pattern data signals in the first set.

8. The method of claim 6, wherein the first set of echo pattern data signals are 2-3-pulse Doppler signals.

9. The method of claim 8, wherein the RF data includes a first set of data points corresponding to a power Doppler signal and a second set of data points corresponding to a second harmonic of the power Doppler signal.

10. The method of claim 9, wherein the first set of data points corresponds essentially to only chamber blood.

11. The method of claim 9, wherein the first set of data points corresponds essentially to both chamber blood and myocardial tissue blood.

12. A software program adapted to implement the method of claim 1, said program being disposed in a tangible medium.

13. A device for conducting perfusion studies on myocardial tissues, comprising:
a transmitter adapted to transmit ultrasound pulses into a patient;
a receiver adapted to receive echoes of said ultrasound pulses which correspond to both myocardial tissue blood and chamber blood within said patient; and
a processor adapted to convert the received ultrasound echoes into image data which corresponds to essentially only the myocardial blood.

14. The device of claim 14, wherein said processor is adapted to eliminate from the second data set echo pattern data signals which positionally correspond to features which produced echo pattern data signals in the first set.

15. A method for conducting perfusion studies on myocardial tissues with contrast agents, comprising the steps of:
transmitting ultrasound pulses into a patient;
receiving ultrasound echoes of the pulses which correspond to blood in both the patient's myocardial tissues and chamber; and
converting the received ultrasound echoes into image data which corresponds to essentially only myocardial perfusion.
